(19) United States
(12) Patent Application Publication
(10) Pub. No.: US 2009/0240707 A1
(43) Pub. Date: Sep. 24, 2009

(54) EVENT DRIVEN INPUT DATA VALIDATION

(75) Inventors: Marian C. Bucsa, Delray Beach, FL (US); Charles Leon Matthews, Boynton Beach, FL (US)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/050,523

(22) Filed: Mar. 18, 2008

(51) Int. Cl. G06F 17/30

(52) U.S. Cl. 707/100; 707/E17.001

(57) ABSTRACT

A system for event-driven input data validation is provided. The system includes one or more processors. The system also includes an input data traversal application program interface (API) configured to execute on at least one processor for generating traversal events. Additionally, the system includes an event conversion layer configured to execute on at least one processor for converting the traversal events to an interface required by a validation engine. The system further includes a validation engine configured to execute on at least one processor for determining a validation result based upon the converted traversal events.

### FIELD OF THE INVENTION

The present invention is related to the field of data processing, and more particularly, to techniques for validating input data.

### BACKGROUND OF THE INVENTION

Software systems often create or extract structured data. Structured data created or extracted from a software system, however, may not be valid with respect to its corresponding meta data definition. Accordingly, the structured data must initially be validated. Validation is particularly important in a service-oriented architecture because downstream components may depend on the data provided to the components by other system-provided services.

Validating the structured data can be both expensive in terms of resource utilization and time consuming. Validating structured data with respect to its meta data definition can be especially problematic in the context of time-critical and real-time software systems.

### SUMMARY OF THE INVENTION

The present invention is directed to a system, computer product, and methods for validating structured data. The invention is based on an event-driven approach to data validation.

One embodiment is a system for event-driven input data validation. The system can include one or more processors. The system also can include an input data traversal application program interface (API) configured to execute on at least one processor for generating traversal events. Additionally, the system can include an event conversion layer configured to execute on at least one processor for converting the traversal events to an interface required by a validation engine. The system further can include a validation engine configured to execute on at least one processor for determining a validation result based upon the converted traversal events.

Another embodiment is a computer-implemented method for event-driven data validation. The method can include generating traversal events. The method also can include converting the traversal events to an interface required by a validation engine. The method can further include passing the converted traversal events to the validation engine to determine a validation result.

Still another embodiment is a computer-readable storage medium such as an optical disk or magnetic tape in which is embedded computer-executable code. The computer-executable code can be configured to cause a computer, when loaded onto and executed by the computer, to perform each of the following steps: generate traversal events; convert the traversal events to an interface required by a validation engine, and pass the converted traversal events to the validation engine to determine a validation result.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of an exemplary environment in which a system of event-driven input validation, according to one embodiment of the invention, is utilized.

FIG. 2 is a schematic view of certain operative features of the system in FIG. 1

FIG. 3 is a flowchart of exemplary steps in a method for validating data, according yet another embodiment of the invention.

### DETAILED DESCRIPTION

The invention is directed to systems and methods for validating input data. The invention utilizes an event-driven approach. With the invention, an external parser can perform input data validation so as to ensure that data moving through a software-based system is correct. One aspect is that the invention obviates the necessity of a data source having to implement its own parser since the invention eliminates a need for application changes. Another aspect is that the invention avoids a degradation of system storage performance.

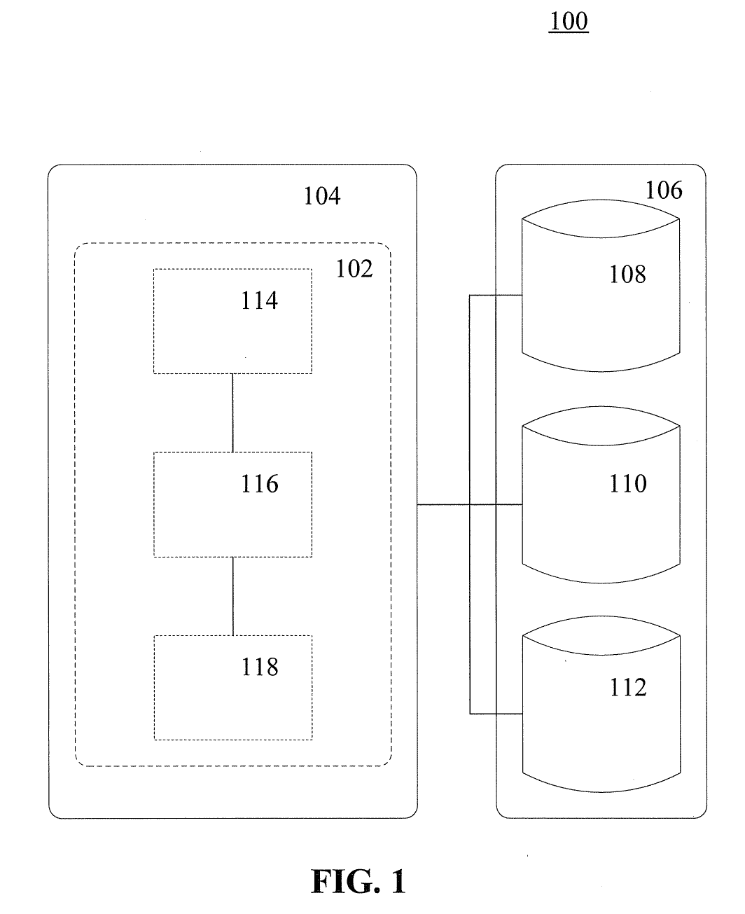

FIG. 1 is a schematic view of an exemplary environment 100 in which a system 102 for validating input data, according to one embodiment, is utilized. Illustratively, the environment 100 includes one or more processors 104, which can comprise registers, logic gates, and other logic-based circuitry (not explicitly shown). The environment also illustratively includes electronic memory 106 for electronically storing data, which as described below can include input data 108, metadata 110, and validation engine metadata 112.

The system 102 for validating input data, more particularly, comprises an input data traversal application programming interface (API) 114, an event conversion layer 116, and a validation engine 118. The system 102 can be implemented is software-based code configured to execute on the one or more processors 104. Alternatively, however, the system 102 can be implemented in dedicated, hardwired circuitry. In still another embodiment, the system 102 can be implemented in a combination of computer-executable code and hardwired circuitry.

In a particular embodiment, the validation engine 118 is WebSphere Transformation Extender (WTX)™, is provided by the International Business Machine Corporation of Armonk, N.Y. The API 114 can be an existing API for traversing input data, such as service data objects, SDO, or DESPI, for example.

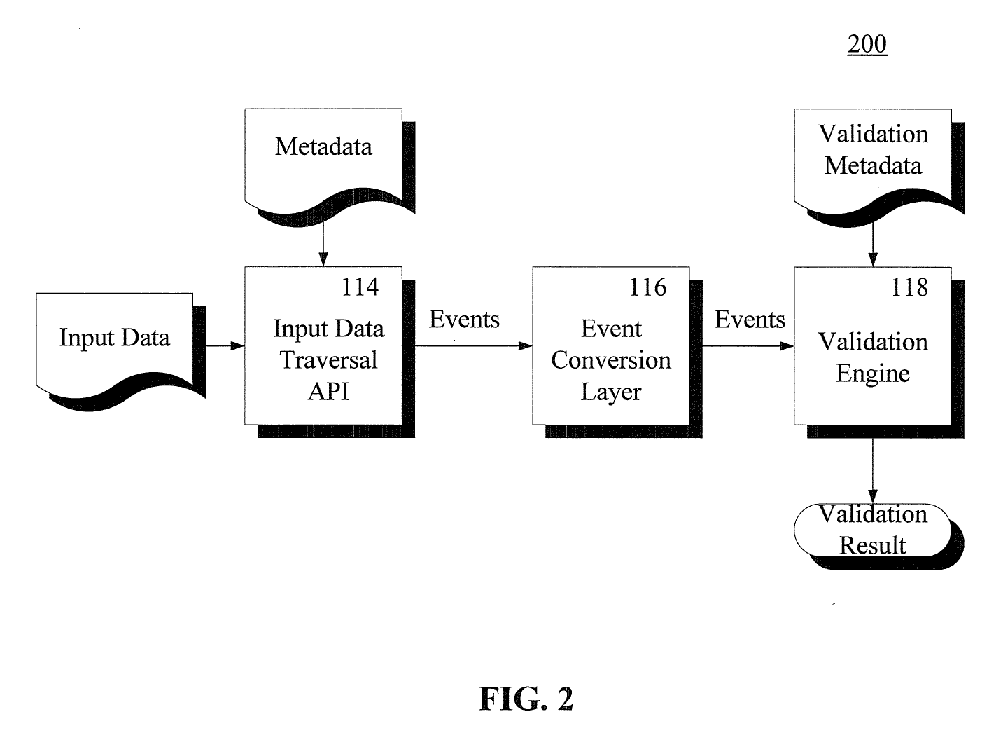

Referring additionally to FIG. 2 certain operative features of the system 102 are schematically illustrated. As used herein, the term “event” encompasses the lowest granularity of the structure of the data, defined by the meta data, that is of interest to the consumer. The triggered objects' meta data is transmitted at the time that the event is raised. Initially, a validation sequence is started by the input data traversal API 114, which is used to generate traversal events. The events so generated are eventually converted to the interface required by the validation engine 118 and are passed then to the validation engine. Metadata information is used by the input traversal API to send type information pertaining to the data to the validation engine 118. The type information is used by the event conversion layer 116 to convert, or adapt, the input events to the interface required by the validation engine 118.

Once the input events are converted, they can support other software-based tools. For example, in one embodiment, the converted input events can support a graphical interface. Additionally, or alternatively, converted input events can support a debugger. Other software-based tools can likewise be supported by the input events once converted by the event conversion layer 116.

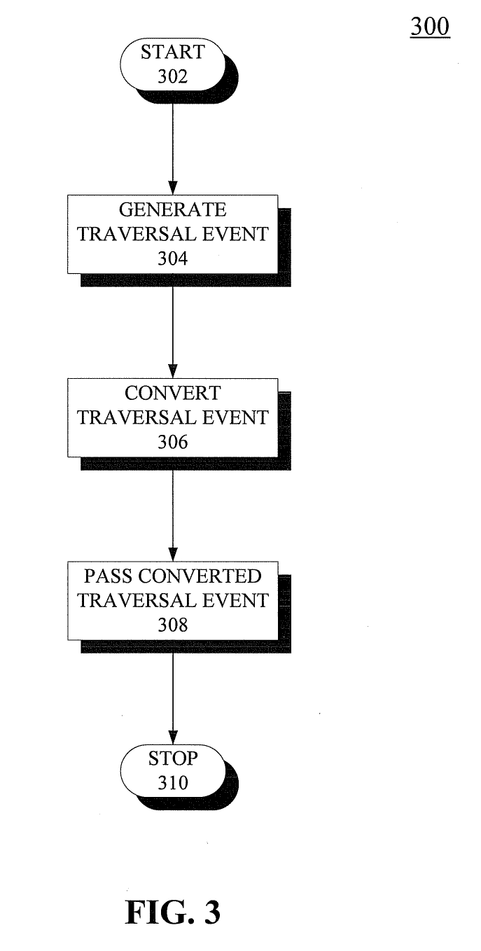

FIG. 3 is a flowchart 300 of exemplary steps in a method for validating data, according yet another embodiment of the invention. The method 300 illustratively includes, after the start at step 302, generating a traversal event at step 304. The method 300 also includes converting the traversal event, at step 306, to an interface required by a validation engine. The method 300 further includes passing the converted traversal event to the validation engine to determine a validation result at step 308. The method illustratively concludes at step 310.

According to one embodiment of the method 300, the traversal event is generated by an input data traversal application program interface (API). The input data traversal API, according to the method 300, can convey type information of input data to the validation engine. The type information, according to the method 300, can be determined based upon metadata information. According to another embodiment of the method 300, the type information can be used to convert the traversal event to the required interface.

In one embodiment of the method 300, the converted traversal events support a graphical interface. According to another embodiment of the method 300, the converted traversal events support a debugger.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, such as an optical disk or magnetic tape, in which is embedded computer-executable code defining a computer program that implements any of the methods aspects described herein when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing descriptions of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for event-driven data validation, the method comprising:
generating a traversal event;
converting the traversal event to an interface required by a validation engine;
passing the converted traversal event to the validation engine to determine a validation result.

2. The method of claim 1, wherein the traversal event is generated by an input data traversal application program interface (API).

3. The method of claim 2, wherein the input data traversal API conveys type information of input data to the validation engine.

4. The method of claim 3, wherein the type information is determined based upon metadata information.

5. The method of claim 3, wherein the type information is used to convert the traversal event to the required interface.

6. The method of claim 1, wherein the converted traversal event supports a graphical interface.

7. The method of claim 1, wherein the converted traversal event supports a debugger.

8. A system for event-driven input data validation, the system comprising:
at least one processor;
an input data traversal application program interface (API) configured to execute on the at least one processor for generating a traversal event;
an event conversion layer configured to execute on the at least one processor for converting the traversal event to an interface required by a validation engine;
a validation engine configured to execute on the at least one processor for determining a validation result based upon the converted traversal event.

9. The system of claim 8, wherein the input data traversal API is configured to convey type information of input data to the validation engine.

10. The system of claim 9, wherein the type information is determined by the input data traversal API based upon metadata information.

11. The system of claim 9, wherein the type information is used by the conversion layer to convert the traversal event to the required interface event.

12. The system of claim 8, wherein the converted traversal event supports a graphical interface.

13. The system of claim 8, wherein the converted traversal event supports a debugger.

14. A computer-readable storage medium comprising computer-readable code for causing a computer to perform the steps of:
generating a traversal event;
converting the traversal event to an interface required by a validation engine;
passing the converted traversal event to the validation engine to determine a validation result.

15. The computer-readable storage medium of claim 14, wherein the traversal event is generated by an input data traversal application program interface (API).

16. The computer-readable storage medium of claim 15, wherein the input data traversal API conveys type information of input data to the validation engine.

17. The computer-readable storage medium of claim 16, wherein the type information is determined based upon metadata information.

18. The computer-readable storage medium of claim 16, wherein the type information is used to convert the traversal event to the required interface.

19. The computer-readable storage medium of claim 14, wherein the converted traversal event supports a graphical interface.

20. The computer-readable storage medium of claim 14, wherein the converted traversal event supports a debugger.
